(19) United States
(12) Patent Application Publication
(10) Pub. No.: US 2012/0158931 A1
(43) Pub. Date: Jun. 21, 2012

(54) Method and Apparatus for the Execution of Adaptable Composed Computer-Implemented Services with Integrated Policies

(75) Inventors: Bõrje Ohlman, Bromma (SE); Carlos Alberto Kamienski, Santo Andre (BR); Djamel Sadok, Jaboatao dos Guararapes (BR); Ramide Dantas, Recife (BR)

(73) Assignee: TELEFONAKTIEBOLAGET L M ERICSSON (PUBL), Stockholm (SE)

(21) Appl. No.: 12/969,331

(22) Filed: Dec. 15, 2010

(51) Int. Cl. G06F 15/173

(52) U.S. Cl. 709/223

(57) ABSTRACT

In one aspect, a method of executing a composed computer-implemented service having at least one policy integrated therein is provided. The method comprises executing a service portion of said composed computer-implemented service, and executing a policy portion of the composed computer-implemented service at substantially the same time as said step of executing said service portion of said composed computer-implemented service. The policy portion of the composed computer-implemented service affects a behavior of the composed computer-implemented service. The policy portion of the composed computer-implemented service and the service portion of the composed computer-implemented service are integrated into a same service code.

### BACKGROUND

Deployment of new business models in areas highly based on technology, such as Internet providers and telecom operators, increasingly depends on adequate IT infrastructure and services. Fierce competition presses companies of various market segments to decrease time to market and introduce new and innovative business models, solutions, services, offers and promotions to attract new users and retain their existing ones.

The business of telecom operators, for example, continuously generates a high demand for improved versions of existing IT systems in order to keep up with new marketing campaigns. In the current IT management scenario, this burden must be quickly absorbed by system development and change management departments where many new problems may arise. Even minor changes frequently require recoding, redeployment and restarting the involved systems. The burden of high demands for software solutions (including new systems and maintenance) on development teams with such tight deadlines are a frequent cause of bugs, which in turn increase the volume of maintenance and change management that otherwise might be avoided. Also, usually IT operations time windows for change management are limited due to other high priority systems, such as critical mission systems and backup systems, which again conflict with the short deadlines of marketing departments.

Currently there is a trend to deploy business processes as services in a Service-Oriented Architecture (SOA). Service Oriented Computing (SOC) is a paradigm that employs “services” as the basic unit for the separation of concerns in the development of computing systems. A SOA provides mechanisms for implementing systems based on the SOC model. Services may be the method whereby consumers access providers' capabilities. Among other interesting features, services provide loosely coupled interaction between partners in a business process (or any other computing activity). Partners can implement services in a variety of different ways and still cooperate as long as clear interfaces are made available.

SOA provides native support for multiple levels of collaboration, both inter- and intra-organization, which makes it a good candidate for modeling business processes as a composition of existing (and new) services. Given a business goal to be fulfilled by an IT service, a series of successive refinements may be performed in order to obtain an adequate service composition.

SOA is believed to facilitate the growth of large-scale enterprise systems, allow Internet-scale provisioning and service usage and reduce costs in the cooperation between organizations. The value of SOA is that it provides a simple scalable paradigm for organizing large networks of systems that require interoperability to realize the value in the individual components. SOA scalability derives from its almost-null assumptions about the underlying network and trust that are often implicitly made in small scale systems.

Composing services into business processes may be a fundamental, yet potentially complex task in service-oriented design. A service composition is a coordinated aggregation of services that have been assembled to provide the functionality required to automate a specific business task or process. Services are expected to be capable of participating as effective composition members, regardless of whether they need to take part in a composition from the scratch. As the sophistication of service-oriented solutions continues to grow, so does the complexity of underlying service composition configurations.

Service orchestration and choreography are two common concepts used to address the complexity of service composition, which consider the coordination or control of individual services in order to make them work together in a coherent manner. Service orchestration refers to coordination at the level of a single participant's process, specifying the control and data flows needed for the process to be executed correctly. Among the several existing languages to describe service orchestration the most representative is Business Process Execution Language for Web Services (WS-BPEL, or just BPEL). Service choreography refers to the protocol that ensures harmony and interoperability among the interacting participants (processes), in order for the processes to cooperate with no dependency on a centralized controller. Choreographies specify the temporal relationship in message exchanging, providing rules to the correct execution of the individual processes. The most accepted language for service choreography is W3C's Web Service Choreography Description Language.

Policy Based Management (PBM) is an approach to simplify the administration of a complex network infrastructure by establishing policies to deal with situations that are likely to occur in a largely automated fashion. The PBM framework developed by the IETF is a model for policy management comprised of Policy Decision Points (PDPs), Policy Enforcement Points (PEPs), policy repository and a Policy Management Tool (PMT). PDPs are responsible for handling requests, querying the policy repository, making decisions and distributing them to the PEPs, which are the entities where the actions are actually implemented and/or enforced. The PMT supports the specification, editing, and administration of policies through a graphical interface. These policies are then stored in the policy repository. Some protocols are necessary within this framework, such as COPS for PDP and PEP interworking and LDAP for the PDP to be able to access policies in the policy repository. Those skilled in the art will appreciate that both COPS and LDAP are only exemplary other protocols may be used.

However, most current useful policies are expressed in a very low-level, technology-oriented language or format, such as firewall rules. And in order to be really useful for higher-level services, such as SOA services, policies also should be expressed in a higher-level, in a business-oriented language. From this gap between higher and lower level policies, emerged the concept of policy refinement, defined as the process of deriving low-level enforceable technology-oriented policies from high-level business-oriented goals or guidelines. A typical methodology for policy refinement is a process of incremental decomposition, where on each refinement step (level) the generated policies are checked for correctness and consistency against the requirements of the policies from previous step. Although policies are intrinsically related to services and the problems of policy refinement and service composition are similar, proposals for both problems together are not common.

There are shortcomings in the current technologies. With respect to SOA and Web Services, in order to obtain the benefits of executing composed services, one must either use a homogeneous Web Service deployment or an Enterprise Service Bus (ESB) as an abstraction layer to incorporate legacy services. With respect to service specification, SOA does not provide unified interfaces for services regardless of the technology of implementation. The SOA reference model developed by the Organization for the Advancement of Structured Information Standards (OASIS) is not a complete specification and Web Services Design Language is narrow in scope. With respect to service process composition and execution, SOA service composition based on service orchestration is usually performed using WS-BPEL, which used alone as a single technology presents some limitations, such as lack of flexibility and dynamic adaptability. A business process represented as a BPEL script is static by nature (i.e. one has to change the script in order to change the behavior of the application). With respect to sub-service selection, SOA does not provide a flexible solution for invocating sub-services, which are used in a service composition. In a WS-PBEL script, sub-services must be invocated explicitly and statically. With respect to policies, SOA does not assume the use of policies for dynamic adaptation of behavior. Policies may have been considered to be used together with Web Services, such as in the WS-Policy standard. However, policies are aimed at expressing capabilities, requirements and constraints of Web Services. With respect to service processes and policies, SOA does not specify how business processes and policies should be integrated into a single environment for service execution. They are usually treated as different entities with different goals. In other words, policies are not considered a part of services, but something apart of them, which may be queried whenever needed for taking decisions.

In sum, although SOA represents an improvement when compared to other solutions to model and deploy new IT services, SOA may lack flexibility to allow systems to dynamically adapt to changing environment conditions.

### SUMMARY

According to an exemplary embodiment, a method of executing a composed computer-implemented service having at least one policy integrated therein is provided. The method comprises executing a service portion of said composed computer-implemented service, and executing a policy portion of the composed computer-implemented service at substantially the same time as said step of executing said service portion of said composed computer-implemented service. The policy portion of the composed computer-implemented service affects a behavior of the composed computer-implemented service. The policy portion of the composed computer-implemented service and the service portion of the composed computer-implemented service are integrated into a same service code.

According to another exemplary embodiment, a method of integrating policies and services in a service refinement cycle is provided. The method comprises specifying a service, mapping the service to a process, the process including a policy operation affecting a behavior of the service, performing the policy operation affecting the behavior of the service to result in a first process outcome, and mapping the first process outcome to an external service.

According to another exemplary embodiment, a service-execution computing system is provided. The service-execution computing system comprises one or more memory devices, and one or more processors configured to execute instructions stored in the one or more memory devices, the instructions configured to perform a method of executing a composed computer-implemented service having at least one policy integrated therein. The method comprises executing a service portion of said composed computer-implemented service, and executing a policy portion of the composed computer-implemented service at substantially the same time as said step of executing said service portion of said composed computer-implemented service. The policy portion of the composed computer-implemented service affects a behavior of the composed computer-implemented service. The policy portion of the composed computer-implemented service and the service portion of the composed computer-implemented service are integrated into a same service code.

According to another exemplary embodiment, a computer-readable medium having instructions to be executed on one or more processors, the instructions configured to perform a method, is provided. The method comprises specifying a service, mapping the service to a process, the process including a policy operation affecting a behavior of the service, performing the policy operation affecting the behavior of the service to result in a first process outcome, and mapping the first process outcome to an external service.

### BRIEF DESCRIPTION OF THE DRAWINGS

The accompanying drawings illustrate various aspects of exemplary embodiments which are described herein, wherein:

FIG. 1 is a schematic representation of a service refinement cycle.

FIG. 2 is a schematic representation of a service execution environment according to an embodiment of the present invention.

FIG. 3 is a schematic representation of a policy web service according to an exemplary embodiment of the present invention.

FIG. 4 is a schematic representation of a virtual flower system according to an exemplary embodiment of the present invention.

FIG. 5 is a schematic representation of a network system according to an exemplary embodiment of the present invention.

FIGS. 6 and 7 are flowcharts illustrating methods according to exemplary embodiments of the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

### OVERVIEW

Embodiments of the present invention are directed to methods and an apparatus for the execution of adaptable composed computer-implemented services based on the Service Refinement Cycle (SRC) framework, where services may be comprised of a set of building blocks (phases) that are frequently found in the service life cycle, but not necessarily together in previous systems. The SRC may contain four phases: service, process, policy, and binding. The execution of a given service may demand the execution of a variety of different sub-services that compose it. Flexibility in execution is provided by making easier the adaptation of the service to changing conditions. Adaptability is a benefit of the SRC, which may be identified in different ways in the four phases. In the service phase, functions may be added/removed/updated while the service is running. The service phase may not know the particular process that implements its service functions, so that service and process phases may be loosely coupled, which makes it possible to change processes dynamically. The policy phase may add adaptability by default since by definition policies allow changes in service behavior. The binding phase may provide late binding which allows internal references to services to be kept in an abstract way.

As noted above, the use of policies for service specification and the role of policies in service execution may be an aspect for providing flexibility for adapting running services to changing conditions and requirements. The method may be accomplished by a service specification (called service code) based on the SRC and the apparatus supporting the method may be a Service Execution Environment (SEE). Embodiments of the present invention may make it possible to conceive of a service that is by design prepared to adapt to typical ever-changing environments, such as the telecom market. Embodiments of the present invention may allow adaptability in various aspects of service execution, inspired in concepts such as late binding of programming languages and Policy-Based Management (PBM). Policies may be a focus of embodiments of the present invention, because they are a powerful mechanism for providing adaptability for running systems.

In early IT systems and network infrastructures, policies were largely used for expressing rules and constraints, represented as parameters stored in system tables. Although they provided some basic levels of flexibility, they were static and limited in nature, because the number of configuration parameters a given system accepted was defined at design time. At the beginning of the 1990s, PBM was proposed as a separate module from the original systems, thus providing an easy way of dynamically adding, removing and updating policies stored in an external database. Embodiments of the present invention reconcile the use of policies and services together, by integrating them in a single system and providing a flexible service specification format and a SEE.

As a result, embodiments of the present invention provide services the ability to quickly adapt as new demands keep coming to IT departments, making it possible to solve many problems in a configuration level, without the need for system recoding or restarting. By “configuration level” it is intended that services may both adapt by the manual intervention of a human operator or by the automated decision of an autonomic component of the system. Therefore, the burden of system development and change management may be alleviated as adaptable composed services may assume the responsibility for dealing with constant modifications of business rules and processes.

### DEFINITIONS

As used herein, the term “service composition” refers to coordinated aggregation of services that have been assembled to provide the functionality required to automate a specific business task or process. The service composing activity may involve the gathering of the necessary parts, as well as the technical means to provide such an aggregation. SOA advocates that any service is expected to be capable of participating as an effective composition member.

As used herein, the term “service creation” refers to a sequence of activities, normally assisted by tools, which embody a business idea as an executable service (embodied as a service code). Service creation may embrace the whole scope of a specification, including the algorithm of the service, its relationships with other services and its execution constraints. In terms of SOA, creation may be also seen as the method through which services interact to become participants of a service composition.

As used herein, the term “service execution” refers to the actual provision and offer of a service to customers. Service execution may be concerned with non-functional requirements that may be observed, such as scalability, robustness and reliability. A feature of service execution may be its ability to follow a standardized service specification format, which is referred to as the service code. The technological environment may be important, on which auxiliary tools may be needed to provide features such as failure notification and service advertising to encourage compositions.

As used herein, the term “service refinement” refers to the transformation of a higher level specification into many lower level ones which together aggregate the same information as the former level. Service refinement may be the method through which a complex (or composed) service is translated into many others which in their turn may be more directly executed by execution environments. Service refinement and composition may be seen as one the opposite of the other, though related. The former goes top-down, where the latter bottom-up. The service refinement cycle may be a framework for simplifying the task of service refinement. However, SRC constituent phases may not be the refinement of each other. Rather, together they may help the refinement of services.

As used herein, the term “policy processing” refers to the processing of policies (as compared with policy specification). Those skilled in the art will appreciate that the specification of policies may be done by a policy administrator system, and may be done with the help of a Policy Management Tool (PMT). Policies may be otherwise specified. For example, in accordance with an embodiment of the present invention, policies may be specified in conjunction with an entire service using appropriate tools. For example, service creation may be performed by a Service Creation Tool (SCT), and editing and updating of a service may be performed by a Service Management Tool (SMT). The processing of policies may involve the finding of matching policies in the storage area of a policy system, the evaluation of policy conditions and the enforcement/execution of specified actions by the applicable policy. In the relevant literature, the terms “policy decision”, “policy enforcement”, “policy evaluation”, “policy processing” and “policy execution” frequently are used freely, without a consensus of their precise meanings The relevant literature focuses on the terms “decision” and “enforcement” only. Policy decision may be defined according to two perspectives. The first may be a process perspective that deals with the evaluation of policy conditions. And the second may be the result perspective that deals with the actions for enforcement. As for policy enforcement, it may be simply defined as the execution of a policy decision. As used herein, policy processing and policy execution will be used as synonyms, including both policy evaluation and policy enforcement.

As used herein, the term “policy refinement” refers to the process of deriving low-level enforceable technology-oriented policies from high-level business-oriented goals or guidelines. A typical methodology for policy refinement may be a process of incremental decomposition, where on each refinement step (level) the generated policies are checked for correctness and consistency against the requirements of the policies from previous step. In the relevant literature, the terms “policy refinement”, “policy translation”, “policy transformation”, “policy mapping” and “policy conversion” may be used either as synonyms or in the definition of each other. Policy transformation may be commonly defined as a superset of policy refinement, which also includes conflict resolution. Policy mapping may be used to mean the final conversion from a policy into device-specific configuration parameters.

Service Refinement Cycle—The Underlying Framework

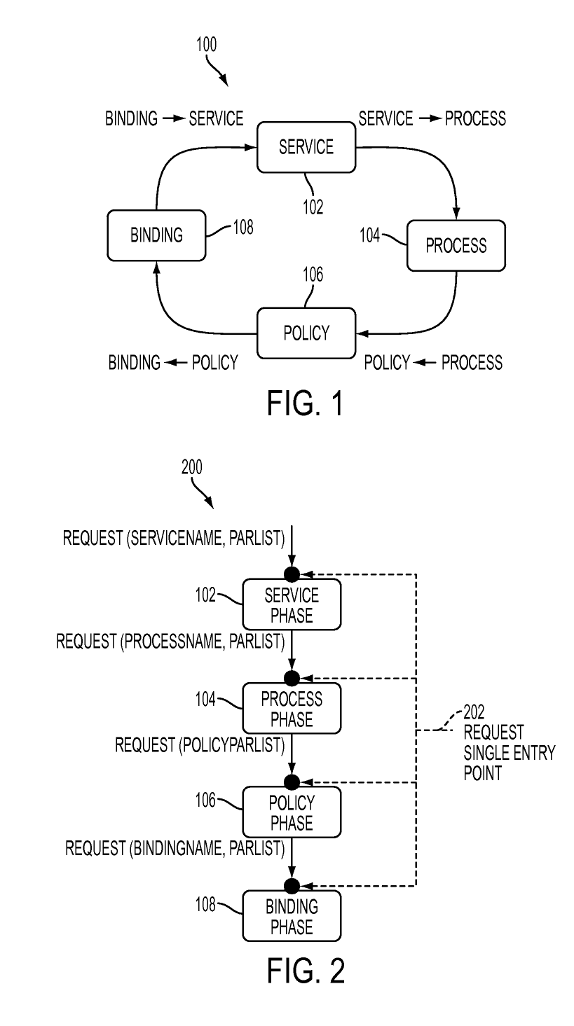

The SRC defines a structure or template for specifying services and may be used as a “common language” for representing some steps of the service life cycle. FIG. 1 depicts the Service Refinement Cycle 100, which may be comprised of four phases: the service phase 102, the process phase 104, the policy phase 106 and the binding phase 108. FIG. 1 also depicts the transitions between any pair of sequential phases. Phases may provide the building blocks that may be needed in order to execute a service expressed as a composition of other existing sub-services. This feature may be used as an enabler for service refinement by particular techniques and tools during service creation.

Phases of the SRC may contain the information that defines a service, which may be generated during service creation where the user may be assisted by an appropriate tool. The goal of and reasoning for each phase is as described below.

The service phase 102 may contain a standardized service description following the SOA paradigm that assumes that services may be widely advertised and information that makes the service phase 102 compatible with the OASIS Reference Model for SOA.

The process phase 104 may be comprised of one or more abstract tasks (not real services yet), which may interact with each other in certain ways. Complex services may be specified as a composition of other services, which follow a process.

The policy phase 106 in service refinement according to exemplary embodiments may provide flexibility to the composition of services and the consequent capability to adapt behavior on demand. Although all four phases might in principle be changed in real-time, the policy phase 106 may be the easiest and most powerful phase that may be changed in real time. Polices according to an embodiment of the invention have novel features that provide them with additional capabilities for expressing actions. Whereas traditionally policies are mostly used for access control and related activities, in an embodiment of the present invention, policies may have a broader usage, which make policies more appropriate for providing flexibility in service specification and execution. Policy enforcement, represented by both constraint checking and action execution, is performed by invoking new services. In other words, according to exemplary embodiments policies are used within the specification of services and policies have the ability to call other services, thus characterizing the deep connection of policies with the service refinement cycle.

The binding phase 108 may provide isolation from internal phases (service phase 102, process phase 104 and policy phase 106) to the outside world (i.e., the binding phase 108 may perform the mapping between internal and external service requests). The other phases of the SRC may refer to services as abstract tasks with known inputs and outputs and may be bound to external services by the binding phase 108.

At runtime, the service execution environment may process the instructions (service code) within each phase of the cycle and follow the transitions between phases. The transitions between phases are described below.

Binding Phase 108→Service Phase 102 (out→in): During execution, a service function from the Application Programming Interface (API) may be selected upon a request from an external service. In case the requested API function does not exist, or the request is incorrect, an error message may be returned to the requesting service. Otherwise, a request may be generated so that the execution flow follows to the next phase (default may be process phase 104).

Service Phase 102→Process Phase 104: Upon receiving a request from the service phase 102, a process may be searched and eventually selected for execution. There may be at least one process for each service API function, but a function may not be statically bound to a process.

Process Phase 104→Policy Phase 106: As the execution of the process starts, each step may request a policy for applying rules, constraints and taking actions as needed. A process step may issue a request to the policy phase 106 and a policy may be dynamically selected to match the process step.

Policy Phase 106→Binding Phase 108: A service may be invoked from within the policy phase 106 to fulfill its policy tasks, e.g., to change the behavior of the service by placing constraints on the implementation of the service (as one example). The transition to the binding phase 108 may be executed in order to match an internal service request to an external reference.

Binding Phase 108→Service Phase 102 (in→out): Δn external function may be requested as a mapping from an internal request. The external service may be implemented by the same entity, by another entity of the same domain, by another entity of a different domain and finally by a non-SOA service.

Service Code—The Method

The main realization of the SRC may be the service code, which may contain executable specifications (code) for the four phases of the cycle. In other words, the service code may be the outcome of the process of service creation when it is developed according to the SRC. If the content of the service code is packed into a standard file (similar to a .jar file), any compatible engine may be able to execute it.

Service code may not depend on any particular technology and may be implemented using any appropriate technology. Different technologies or languages may be used for each phase of the service code. Exemplary technology for each phase is described below.

The service phase 102 may be influenced by the OASIS SOA Reference Model. The most acknowledged standard for service interfacing is web service description language. Nevertheless, because of discovery and composition automation possibilities, specification in ontology languages, such as the Open Group SOA Ontology, based on OWL, and other semantic-enabled technologies as Web Service Modeling Language may be appropriate.

The process phase 104 may be specified by a process specification language, such as WS-BPEL or Java. Alternatively, a process may be specified by a semantic-enabled language, such as OWL-S.

The policy phase 106 may be specified by traditional policy languages (e.g. XACML or Ponder). Alternatively, ontology-enabled languages (e.g. Rei and OWL enhanced by SWRL) may be used for writing policies.

The binding phase 108 may be specified by OWL. In its simplest form the binding phase 108 may be implemented as a table that maps internal references to abstract services to the invocation of external real services.

Service Execution Environment—The Apparatus

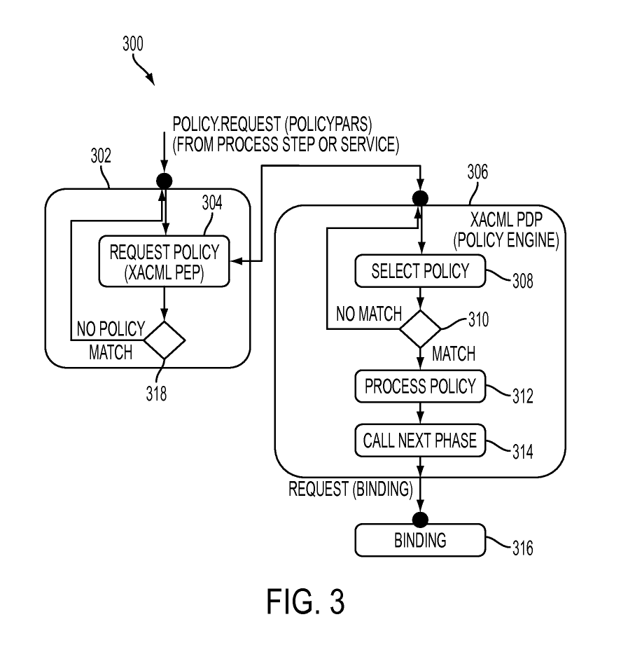

Service execution may be the process of reading service code and executing service code in sequence, performed by a Service Execution Environment (SEE). Given that the SRC is a standard specification of services, automation of service execution may be possible by any engine that implements the features described herein. During the execution of a service specified according to the SRC, the refinement is actually unfolded. In other words, the execution itself is the actual refinement in operation. FIG. 2 presents a novel architecture 200 of a SEE, pointing out that each phase 102, 104, 106, 108 receives requests in a single entry point 202.

The transitions between phases may be dynamically bound by default, which means that one phase may send a call to the other phase, which will be evaluated in runtime by the execution engine.

Algorithm 1 (below) depicts a high-level algorithm for the policy phase 106 (method Policy.Request). Algorithm 1 selects policies using parameters and if the policy set returned is not null, Algorithm 1 resolves conflicts (in case two or more policies are selected) and executes actions (if actions are found). Two additional algorithms are provided (Policy.Select and Policy.ExecuteAction) because they involve the Binding Phase 108. The policy selection algorithm may retrieve policies that match some simple criteria (e.g., target in XACML) and proceeds to analyze additional conditions for each policy individually. Some additional parameters needed for condition evaluation may involve the execution of sub-services through a request to the binding phase 108, as expressed in the Policy.GetAdditionalParameters algorithm. The Policy.ExecuteAction algorithm also sends requests to the binding phase.

### Algorithm 1—Policy Phase

```
/* Policy Phase - Entry Point */
Policy.Request(PolicyPars)
  policySet := Policy.Select(PolicyPars);
  if (policySet not NULL) then
    policy := Policy.ResolveConflict(policySet);
    result := Policy.ExecuteAction(policy);
    return(result);
  else
    return(ErrorPolicyNotFound);
  end-if
end
/* Policy Selection */
Policy.Select(policyPars)
  policySet := Policy.RetrievePolicies(PolicyPars);
  foreach policy in policySet do
    AdPars := Policy.GetAdditionalParameters(policy);
    status := Policy.CheckConditions(policy, AdPars);
    if (not status) then
      policySet := policySet − policy;
    end-if
  end-for
  return(policySet);
end
GetAdditionalParameters(policy);
  BindingName := Policy.getBindingName(policy);
  BindingPars := Policy.getBindingParameters(policy);
  AdParList := Binding.Request(BindingName, BindingPars);
  Return(AdParList);
end
/* Action Execution */
Policy.ExecuteAction(action);
  BindingName := Policy.getBindingName(action);
  BindingParList := Policy.getBindingParameters(action);
  result := Binding.Request(BindingName, BindingParList);
  return(result);
end
```

Exemplary Embodiment of the Service Code

As noted above, service code may not depend on any particular technology and may be implemented using any appropriate technology. One exemplary embodiment of the service code may include the technology described below.

The service phase 102 may use an OWL-based service specification, adapted from the Open Group SOA Ontology. The OWL-based service specification is an acknowledged standard for knowledge representation. The OWL-based service specification may permit evolution to a more automated inter-service relationship.

The process phase 104 may use a WS-BPEL language. The WS-BPEL language may simplify the execution of the specification, once no translations nor compiling are necessary after description. WS-BPEL may permit more intuitive business level to execution level transformation.

The policy phase 106 may use an enhanced XACML policy language to support the invocation of bindings, that is, the execution of routines from inside the specification of policies. The structure of policies in this enhanced XACML language is described below.

The binding phase 108 may use a table that maps internal references to abstract services to the invocation of external real services specified in OWL. This table may contain various entries for a given internal abstract service, for making it possible the service to adapt to different conditions by choosing different mappings to external real subservices.

Policy Structure in the Enhanced XACML Language

The eXtensible Access Control Markup Language (XACML) is an XML-based standard that provides a policy language and an access control decision and response language for managing the access to resources. XACML is designed to provide a universal language for authorization policies in order to enable interoperability with a wide range of administrative and authorization tools. In addition to concepts well accepted in the policy management area, such as PDP and PEP, XACML uses other relevant concepts, such as decision request, effect, authorization decision, target, obligation, and condition. These concepts are described below.

A decision request may be a request by a PEP to a PDP to render an authorization decision. An effect may be an intended consequence of a satisfied rule (either “Permit” or “Deny”). An authorization decision may be a result of evaluating applicable policy, returned by the PDP to the PEP that may be “Permit”, “Deny”, “Indeterminate” or “Not Applicable”, and (optionally) a set of obligations. A target may be a part of both policies (that defines its applicability) and decision requests (that characterizes it), composed of a resource (e.g., a service), a subject (e.g., a user), and action (e.g., start). An obligation may be an operation specified in a policy that may be performed by the PEP in conjunction with the enforcement of an authorization decision. A condition may be an expression that evaluates to “True”, “False”, or “Indeterminate”.

In accordance with an exemplary embodiment of the present invention, additional features may be added to XACML in order for making the embodiment suitable to use together with services within the policy phase of the SRC. Specifically, a processing clause, a binding keyword, a priority, and a policy type may be added to XACML. A processing clause may provide policies with enhanced capabilities for expressing actions, in addition to those expressed in the limited “effect” clause. Actions are taken by invoking new services. A binding keyword may be a way of expressing invocation of services indirectly through the binding phase 108, so as to obtain late binding. A priority such as a single priority may be a simple way of performing conflict resolution when many policies may be selected for execution. A policy type may allow for segmentation of policies into different classes. The segmentation of policies into different classes may be useful in different applications of services. Different classes of policies may be defined by the policy type.

Embodiment of the Service Execution Environment

The SEE may be developed using a variety of technologies, according to different expectations of performance, flexibility and compatibility with existing technologies. An exemplary embodiment based on Web Services is described below. Web Services is the most common technology for implementing SOA.

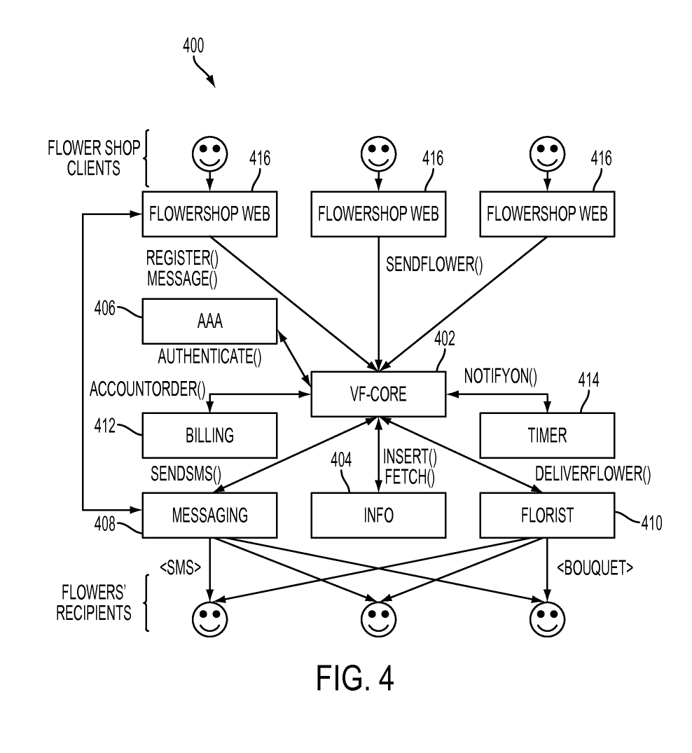

In an exemplary embodiment, the SEE may be implemented in each phase as a Web Service, which may provide flexibility and compatibility with current state-of-the-art technology. This may not be the same as directly using Web Services for service execution because in this exemplary embodiment of the SEE, many levels of adaptability may be introduced as described previously. FIG. 3 is a schematic representation of a policy web service 300 according to this exemplary embodiment. The policy web service 300 may be a wrapper for a XACML platform, comprised of a Policy Enforcement Point (PEP) and a Policy Decision Point (PDP). Using the XACML terminology, the policy web service 300 may function as a context handler that translates the requests received by its entry point into a XACML request that may be understood by a XACML policy engine (the PDP). XACML policies may obtain additional information by calling another service through the binding phase.

As shown in FIG. 3, a decision request may be made from the PEP 302 to the PDP 306. In operation 308, an applicable policy may be selected. In operation 310, a determination may be made whether an applicable policy has been selected. If in operation 310, it is determined that an applicable policy has not been selected, the PDP 306 may return a determination of “Not Applicable”. If in operation 310, it is determined that an applicable policy has been selected, an authorization decision may be determined by evaluating the applicable policy in operation 312. If the policy is not matched, i.e., a policy's condition(s) are not met, the PDP 306 may return a determination of “Deny”. If the policy is matched, i.e., the policy's condition(s) are met, the PDP 306 may return a determination of “Permit”. In operation 314, a next operation may be called and bound (operation 316) using the binding keyword.

Exemplary Embodiment: Virtual Flower Scenario

The execution of adaptable composed services according to exemplary embodiments may be applied to a variety of scenarios. To illustrate some of the benefits of, for example, integrating policy into service composition as described above, a non-limiting and purely illustrative exemplary scenario including an MMS and flower delivery service called Virtual Flower (VF) is presented next as an example of using service code with integrated policies to specify a new service. The VF scenario lets a customer send virtual or real flower bouquets to another person, such as their mother on Mother's Day. A virtual flower consists of an MMS message sent via a telecom operator (messaging service). For the real flower service, one receives the virtual bouquet and is also asked for delivery instructions for the real bouquet. For this discussion, it is assumed that a real service provided by a flower vendor (florist) is available and willing to cooperate. Therefore, the challenge is how to create this new VF service, out of messaging and florist services and other support services.

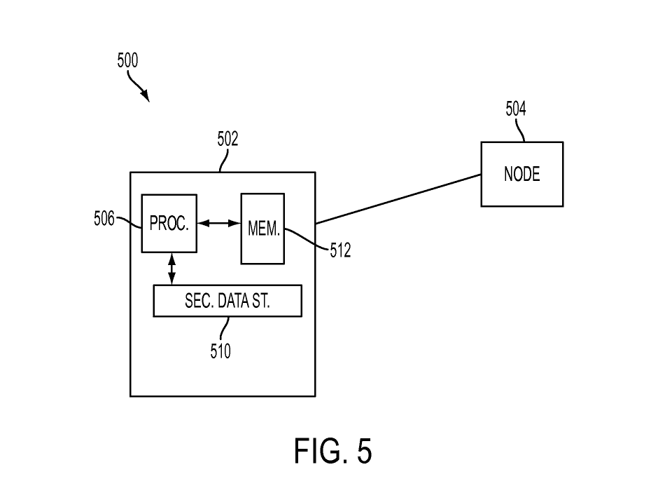

FIG. 4 is a schematic representation of a virtual flower system 400 according to an exemplary embodiment of the present invention. The virtual flower system 400 may include a main service, VF-Core 402, and six sub-services: info service 404, Authentication, Authorization, and Accounting (AAA) service 406, messaging service 408, florist service 410, billing service 412 and timer service 414. Customers may interact with the VF service via a Web interface 416, called FlowerShop, which may run on different devices and platforms, ranging from, for example, a desktop to a smartphone. VF-Core 402 may be the main service (i.e. the higher-level service in charge of the coordination of the other services, by composing them using the concepts of the SRC). Info service 404 may be a support service that provides information storage and retrieval features, and also capabilities of managing groups of files and attributing usage permissions to users. All information dealt with by VF-Core may be stored in the Info service 404, transparently for the user. AAA service 406 may be responsible for authentication, authorization and accounting. The billing service 412 may handle payments and the timer service 414 may be used to schedule future events, such as flower delivery. The messaging service 408 may be a telecom operator that may send a message such as an MMS message. The florist service 410 may be a flower vendor.

Service Specification

A service specification for the VF scenario is presented according to an exemplary embodiment. Those skilled in the art will appreciate, however, that the present invention is not restricted to this particular embodiment. As SRC describes an abstract way of refining a service, it does not specify a precise representation of how to refine a service.

Virtual Flower: Service Phase

The service phase 102 may contain the textual description of the VF service, along with details of how to connect and to invoke the service functions provided by the API, which may be used by computers or by system developers. In the former case, the service description may be carefully specified (e.g. using some ontology, for automated service composition and usage). In the latter case, services are discovered and accessed manually and the service phase resembles a common API description. According to the exemplary embodiment, service description is described in as simple a manner as possible (VF service used by system developers) in the interest of clarity.

Table 1 presents an exemplary service description, with 3 functions. The deliverVFlower function may allow sending virtual flowers and must receive as parameters: flower identification (flr-id), destination and source mobile phone numbers (dst-nr and src-nr (e.g. mother and child phone numbers)); user identification (uid (e.g. child)) and the payment method (e.g. credit card number). The expected real effect of this function may be the delivery of the virtual flower to the target person. Users may receive back in their phone an SMS message (sms-ack) confirming the delivery of the virtual flower. The deliverRFlower function may allow sending both virtual and real flowers and thus the deliverRFlower function may need the mother's address (addr) as an additional parameter relative to the deliverVFlower function. The getFlowerList function may be used for showing the list of all available flowers with information such as id, name, description, picture, availability and price. More information about each service API function may be required, such as: a textual description; behavior model (service usage flow); next phase (default may be process phase 104); constraints (which may be a subset of the policies in the Policy Phase 106, expressed in a more user-friendly way than in a policy language).

At preparation time this service description API may be used in the refinement of other services. As for execution time, upon receiving a request for one of the service description's functions, the execution engine looks up the service API and if a function is matched (name and parameters), it will proceed to the next phase (process phase 104). In turn, a process with the same name and parameters will be looked up in the process phase 104.

TABLE 1
Service API

| Name | Parameters | Next |
|---|---|---|
| deliverVFlower | flr-id, dst-nr, src-nr, uid, pay-meth | Process |
| deliverRFlower | flr-id, dst-nr, src-nr, addr, uid, pay-meth | Process |
| getFlowerList | — | Process |

Virtual Flower: Process Phase

Each function of the service API may require a different process to be refined into a composition of other services, with some extra functionality added. Table 2 presents an exemplary service to process mapping, which contains the service name with additional parameters and an equivalent process name that implements it. This mapping may be needed because different processes may be used for implementing a given service and during the service life cycle they may be changed in order to adapt to different environment conditions.

TABLE 2
Service to Process Mapping

| Function Name | Parameters | Process Name |
|---|---|---|
| deliverVFlower | flr-id, dst-nr, src-nr, uid, | deliverVFlower_process_v1 |
| | pay-meth | |
| deliverRFlower | flr-id, dst-nr, src-nr, | deliverRFlower_process_v1 |
| | addr, uid, pay-meth | |
| getFlowerList | — | getFlowerList_process_v1 |

A process that implements the deliverRflower function with six steps is presented in Table 3. In addition, a graphical representation of the process may be used to help improve the understanding of the service function and may be part of the service description. In Table 3 each step has a name, parameters and the next phase (that may differ for each step). Table 3 presents the service to be invoked only as a clarification, because the real service may only appear in the binding phase. Furthermore, when the next phase is the policy phase 106, there may be no control over what service is to be called by the selected policy.

If any process step fails (in any phase), an action may occur. For example, control may be returned to the process phase and in turn an error message may be sent to a service consumer.

TABLE 3
Process deliverRFlower_process_v1

| Step # | Name | Parameters | Next | Service |
|---|---|---|---|---|
| 1 | authenticateUser | Uid | Policy | AAA |
| 2 | ageRequirement | Uid | Policy | Info |
| 3 | chargeUser | uid, pay-meth | Policy | Billing |
| 4 | getPicture | flr-id | Binding | Info |
| 5 | sendMMS | flr-img, dst-nr, | Binding | Messaging |
| | | src-nr | | |
| 6 | deliverFlower | flr-img, addr, | Binding | Florist |
| | | dst-nr, src-nr | | |

Virtual Flower: Policy Phase

Many different rules and constraints may be applied to the process of sending virtual and real flowers using one or more policies to affect the service behavior. Algorithm 2 below depicts three exemplary policies that may be processed as a result of the requests to the policy phase made by the process of the deliverRFlower function (Table 3 steps 1, 2 and 3). In this exemplary embodiment, these three policies are specified in an enhanced XACML language (although simplified for visualization), added with an explicit support for the refinement cycle, represented by the binding keyword within the condition clause. As represented in Algorithm 2, the policy may only be selected for execution when the target field (subject, resource, action) matches the request and the condition is satisfied. Since the condition may contain a request for a service via the binding phase 108, the corresponding service may be executed during policy evaluation. Policies may be given priorities and whenever two or more policies are selected for execution according to their target and condition, the policy with the highest priority may be selected (not represented in Algorithm 2).

For example, Policy P1 may be executed for any subject provided in the request if the resource is a flower, the action is an authentication and this user is successfully authenticated by an external service. Policy P2 may deny authorization for customers under 18 years old. Policy P3 may charge customers. If the payment is successfully confirmed, Algorithm 2 may permit the transaction to be concluded. Those skilled in the art will appreciate that the binding keyword could be also used within the processing clause of a policy, where explicit policies actions are performed.

### Algorithm 2—Policies for deliverRFlower

```
Policy P1; Priority = 1
  Target: subject = any-user; resource = any-flower; action = authenticate
  Condition: Binding::authenticateUser(uid) == ok
  Effect: Permit
Policy P2; Priority = 1
  Target: subject = any-user; resource = any-flower; action = authorize
  Condition: Binding::getUserAge(uid) < 18
  Effect: Deny
Policy P3; Priority = 1
  Target: subject = any-user; resource = any-flower action = charge
  Condition: Binding::chargeUser(uid, price, pay-meth) == ok
  Effect: Permit
```

A policy request may contain additional parameters (other than “target”) that are used for evaluating the condition and in the processing clause (where general actions may be executed). As an example, policies P1, P2 and P3 may use parameters uid (user identifier), price and pay-meth (payment method).

Virtual Flower: Binding Phase

In its simplest form, the binding phase 108 may be a mapping from an internal to an external request, as shown in Table 4. Those skilled in the art will appreciate that Table 4 may not contain actual syntax, but rather exemplary representations to emphasize that an external service may be called. In this example, the first 3 bindings come from the policy phase 106 and the last 3 ones come from the process phase directly. When a request for a binding is received, the execution engine may match internal with external requests, including parameters (not shown in the table).

TABLE 4
Bindings for Virtual Flower

| Internal Service | External Service |
|---|---|
| authenticateUser | soap://aaa.com/authenticate |
| getUserAge | soap://storage.com/getAge |
| chargeUser | soap://billing.com/charge |
| getPicture | soap://storage.com/getPicture |
| sendMMS | soap://messaging.com/sendMMS |
| deliverFlower | soap://florist.com/deliver |

Service Code

A service description may be represented by the service code. An exemplary service code for the policy phase 106 is presented in Algorithm 3. Algorithm 3 shows a XACML policy used to describe the policy phase 106. The snippet shows a policy's ability to address external invocation in order to perform its entitlement.

### Algorithm 3—Service Code for the Policy Phase: XACML

```
<Policy PolicyId=“PORBilling” RuleCombiningAlgId=“priority-
combining” Priority=“1” Type=“accounting” Active=“true”>
  <Target>
    ...
  </Target>
  <Rule RuleId=“R1” Priority=“1” Effect=“Permit”>
    <Condition FunctionId=“urn:oasis:names:tc:xacml:1.0:function:and”>
      <Apply FunctionId=“urn:oasis:names:tc:xacml:1.0:function:string-
      equal”>
        <Apply FunctionId=“invoke-web-service”>
          <AttributeValue
DataType=“http://www.w3.org/2001/XMLSchema#string”>http://
192.168.0.142:9090/Binding Service/BindingService?wsdl
</AttributeValue>
          <AttributeValue
DataType=“http://www.w3.org/2001/XMLSchema#string”>execute
</AttributeValue>
          <AttributeValue
DataType=“http://www.w3.org/2001/XMLSchema#string”>chargeUser
</AttributeValue>
          <Apply FunctionId=“to-array”>
            <Apply FunctionId=
            “urn:oasis:names:tc:xacml:1.0:function:string-one-and-
            only”>
              <ActionAttributeDesignator AttributeId=“Creditcard”
DataType=“http://www.w3.org/2001/XMLSchema#string”/>
            </Apply>
            <Apply FunctionId=
            “urn:oasis:names:tc:xacml:1.0:function:string-one-and-
            only”>
              <ActionAttributeDesignator AttributeId=“Price”
DataType=“http://www.w3.org/2001/XMLSchema#string”/>
            </Apply>
          </Apply>
        </Apply>
        <AttributeValue
DataType=“http://www.w3.org/2001/XMLSchema#string”>true
</AttributeValue>
      </Apply>
    </Condition>
  </Rule>
</Policy>
```

Adaptability in Service Execution

Alternative scenarios related to the VF service are now described to highlight the different execution paths for the service code, showing the flexibility of the service code to adapt to changing environment conditions. New requirements may be introduced to the service, which may represent changes to the four phases of the service, and are as presented below.

As a first requirement, the service described above may only support present service delivery (i.e., virtual or real flowers may only be sent at purchase time). In order to provide a variation of this service to support scheduled flower delivery, the timer service 414 may be used.

As an additional requirement, the VF service provider may now want to create a prepaid system for the flower shop and a fidelity program, so that registered users will be charged differently and they will obtain bonus points for their accounts. Therefore, a new policy for charging customers may be needed, which may have priority over the existing policy (Policy P3, in Algorithm 2).

As an additional requirement, if the SLA with the messaging service is violated (i.e., the response time is too high), then a second messaging service (a backup) may be called.

As a last requirement, new florists may be introduced and now the selection of the most appropriate florist may depend on different variables, such as geographical location.

Extended Virtual Flower: Service Phase

In order to fulfill these new requirements, the VF Service API may be extended in the service phase as shown in Table 5, with two new functions, deliverScheduledRFlower and selectFlorist (the other functions and the column Parameters are omitted in the interest of clarity). deliverScheduledRFlower and selectFlorist may be needed for fulfilling the first and the last requirements (above) respectively.

TABLE 5
Extended VF Service API

| Name | Next |
|---|---|
| deliverScheduledRFlower | Process |
| selectFlorist | Process |

Extended Virtual Flower: Process Phase

As shown in Table 6, the implementation of deliverRFlower function may be split into two parts, and as a result two new processes may be needed. The first may end when the first function calls the timer service 414 and the second begins when the second is called by the Timer Service. Therefore a second version of the process for the deliverRFlower and a new process for sending flowers at the scheduled time may be added to the table. Also, a new process for implementation the selectFlorist method may be needed.

TABLE 6
Service to Process Mapping

| Service Name | Process Name |
|---|---|
| deliverRFlower | deliverRFlower_process_v2 |
| deliverScheduledRFlower | deliverScheduledRFlower_process_v1 |
| selectFlorist | selectFlorist_process_v1 |

Table 7 depicts the second version of a process that may implement the deliverRFlower service. It may contain the first three steps of the first version (Table 3) and a fourth step for calling the timer service 414 in order to schedule the flower delivery.

TABLE 7
Process deliverRFlower_process_v2

| Step # | Name | Next | Service |
|---|---|---|---|
| 1 | Authenticate-User | Policy | AAA |
| 2 | Age-Requirement | Policy | Info |
| 3 | Charge-User | Policy | Billing |
| 4 | Schedule-Delivery | Binding | Timer |

Table 8 depicts a process for a scheduled flower delivery, which may be composed of the last three steps of the first version (Table 3).

TABLE 8
Process deliverScheduledRFlower_v1

| Step # | Name | Next | Service |
|---|---|---|---|
| 1 | Get-Picture | Binding | Info |
| 2 | Send-MMS | Binding | Messaging |
| 3 | Deliver-Flower | Binding | Florist |

New Virtual Flower: Policy Phase

In order to address the brand new class of prepaid registered users, a new policy may be created, which is policy P4 in Algorithm 4. Now the subject is the group prepaid-user, whereas in Algorithm 2 it is any-user. It should be noted that both policies P3 and P4 will be selected for execution according to their target, because a prepaid user is a subset of the whole user base. Therefore, policy P4 may be assigned a priority of 2, in order to force it to be selected over policy P3. The result may be that when the customer is a registered prepaid user, policy P4 may be selected and a different billing method may be used. This policy also may credit a bonus to the user account in accordance with the flower shop fidelity program. As a result, two new services may be created, prepaid service and fidelity-program service, which provide in their service API the functions debitUser and creditBonus, respectively.

### Algorithm 4—Policies for the New deliverRFlower

```
Policy P4; Priority = 2
    Target: subject = prepaid-user; resource = any-flower action = charge
    Condition: Binding::debitUser(uid, price) == ok
    Processing: Binding::creditBonus(uid, price) == ok
    Effect: Permit
```

New Virtual Flower: Binding Phase

As a result of the new requirements, in the binding phase 108 two service calls may be changed (sendMMS and deliverFlower) and three new service calls may be created (scheduleDelivery, debitUser and creditBonus). The service call sendMMS may have a new level of resilience, by using a backup messaging service (called Messaging 2) whenever the main service does not respond in a fixed time. The service deliverFlower may be modified to call the internal service API function selectFlorist that in turn will select the most adequate (cost-effective and timely) florist providers.

Also, the scheduleDelivery service call may use the timer service 414 to schedule a future flower delivery, and debitUser and creditBonus may use the new prepaid service and fidelity-program service, respectively.

TABLE 9
Bindings for Virtual Flower

| Internal (Abstract) Service | External (Real) Service |
|---|---|
| sendMMS | Try |
| | soap://messaging.com/sendMMS |
| | catch TimeoutError |
| | soap://messaging2.com/sendMMS |
| deliverFlower | internal://selectFlorist |
| scheduleDelivery | soap://timer.com/scheduleService |
| debitUser | soap://prepaid.com/debit |
| creditBonus | soap://fidelity-program.com/creditBonus |

Embodiments of methods and apparatus for the execution of adaptable composed computer-implemented services have been presented. According to exemplary embodiments of the present invention, improved ability to adapt behavior according to changes in the environment is possible, mainly due to the user of policies. Further, exemplary embodiments provide portability by permitting the execution of a service description in many heterogeneous environments, given the use of a well-known service code (that may be standardized in the future) and standard technologies. Further, exemplary embodiments provide separation of concerns of service description attributes in well-defined modules, for the sake of organization. This may be a reason for dividing up service composition into four phases. Such an approach may provide independence between phases when designing a new service. Service description, process and policies may be even created by different people or different intelligent systems, regardless of the actual services that will implement the external functions to be invoked.

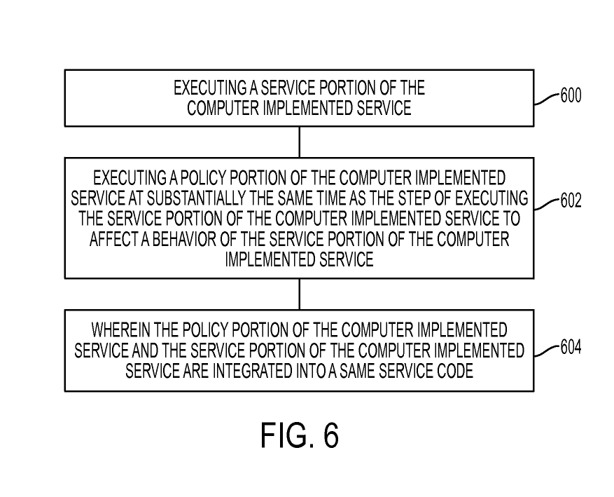

FIG. 5 is a schematic representation of a service-execution computing system 500 according to an embodiment of the present invention. Methods and apparatus for execution of adaptable computer-implemented services according to exemplary embodiments of the present invention may be performed by one or more processors 506 executing sequences of instructions contained in one or more memory devices 512. Such instructions may be read into the one or more memory devices 512 from other computer-readable mediums such as secondary data storage device(s) 510. Execution of the sequences of instructions contained in the memory device 512 may cause the processor 506 to operate, for example, as described above. Methods and apparatus for execution of adaptable services according to exemplary embodiments of the present invention may be performed by a network system such as one comprising multiple nodes 502, 504. In alternative embodiments, hard-wire circuitry may be used in place of or in combination with software instructions to implement the present invention.

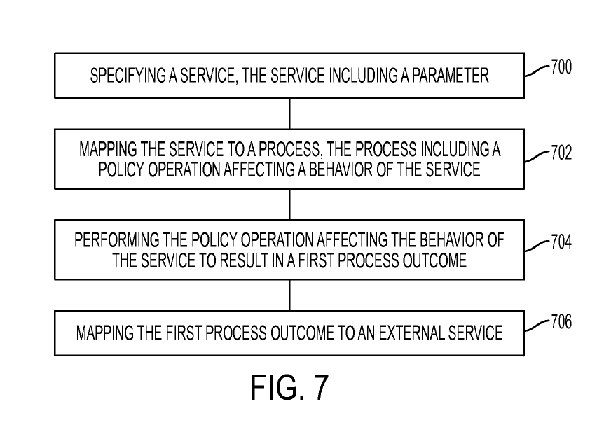

According to one exemplary embodiment, a method of executing a composed computer-implemented service having at least one policy integrated therein includes the steps illustrated in FIG. 6. Therein, a service portion of the composed computer-implemented service is executed as step 600. A policy portion of the composed computer-implemented service is then executed at substantially the same time as the step of executing the service portion of the composed computer-implemented service as indicated by step 602, to affect a behavior of the service portion of the composed Web service. As indicated by block 604, the policy portion of the composed computer-implemented service and the service portion of the composed computer-implemented service are integrated into a same service code.

According to another exemplary embodiment, a method of integrating policies and services in a service refinement cycle is illustrated in the flowchart of FIG. 7. Therein, a service is specified, the service including a parameter at step 700. The service is mapped, at step 702, to a process, the process including a policy operation affecting a behavior of the service. The policy operation is performed at step 704 to affect the behavior of the service to result in a first process outcome. At step 706, the first process is mapped to an external service.

Numerous variations of the afore-described exemplary embodiments are contemplated. The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, used herein, the article “a” is intended to include one or more items.

What is claimed is:

1. A method of executing a composed computer-implemented service having at least one policy integrated therein, the method comprising:
executing a service portion of said composed computer-implemented service; and
executing a policy portion of the composed computer-implemented service at substantially the same time as said step of executing said service portion of said composed computer-implemented service to affect a behavior of the service portion of the composed computer-implemented service, and
wherein the policy portion of the composed computer-implemented service and the service portion of the composed computer-implemented service are integrated into a same service code.

2. The method of claim 1, wherein the composed computer-implemented service comprises a flower delivery service, the service portion comprises a deliver real flowers function, the policy portion comprises an age verification function, and wherein if the age verification function fails, the deliver real flowers function fails.

3. The method of claim 1, wherein said step of executing a policy portion of the composed computer-implemented service further comprises:
imposing a constraint on the service portion of said composed computer-implemented service if a predetermined condition is met.

4. The method of claim 3, wherein said step of executing a policy portion of the composed computer-implemented service further comprises:
calling, by said policy portion, a service to implement said constraint.

5. The method of claim 1, wherein the service portion of the composed computer-implemented service and the policy portion of the composed computer-implemented service are defined in different languages.

6. The method of claim 5, wherein the policy portion of the composed computer-implemented service is defined in a declarative access control language.

7. The method of claim 6, wherein the policy portion of the composed computer-implemented service is defined in an enhanced eXtensible Access Control Markup Language.

8. The method of claim 7, wherein the enhanced eXtensible Access Control Markup Language comprises a binding keyword and a processing keyword.

9. The method of claim 1, wherein the service portion of the composed computer-implemented service is defined in a Business Process Execution Language (BPEL).

10. The method of claim 1, wherein the composed computer implemented service comprises a composed Web service.

11. A method of integrating policies and services in a service refinement cycle, the method comprising:
specifying a service;
mapping the service to a process, the process including a policy operation affecting a behavior of the service;
performing the policy operation affecting the behavior of the service to result in a first process outcome; and
mapping the first process outcome to an external service.

12. The method of claim 11, further comprising:
modifying the policy operation of the process;
performing the modified policy operation affecting the behavior of the service to result in a second process outcome; and
mapping the second process outcome to an external service.

13. The method of claim 11, wherein the specifying of the service and the performing of the policy operation are performed using different languages.

14. The method of claim 13, wherein the performing the modified policy operation is performed using a declarative access control language.

15. The method of claim 14, wherein the performing of the modified policy operation is performed using an enhanced eXtensible Access Control Markup Language.

16. The method of claim 15, wherein the enhanced eXtensible Access Control Markup Language includes a binding keyword and a processing keyword.

17. The method of claim 13, wherein the specifying of a service is performed using a Business Process Execution Language.

18. The method of claim 11, wherein the mapping of the service to the process is defined in Business Process Execution Language for Web Services.

19. The method of claim 11, wherein the mapping of the first process outcome is performed using Web Ontology Language.

20. A service-execution computing system, comprising:
one or more memory devices; and
one or more processors configured to execute instructions stored in the one or more memory devices, the instructions configured to perform a method of executing a composed computer-implemented service having at least one policy integrated therein, the method comprising:
executing a service portion of said composed computer-implemented service; and
executing a policy portion of the composed computer-implemented service at substantially the same time as said step of executing said service portion of said composed computer-implemented service to affect a behavior of the service portion of the composed computer-implemented service, and
wherein the policy portion of the composed computer-implemented service and the service portion of the composed computer-implemented service are integrated into a same service code.

21. The service-execution computing system of claim 20, wherein said step of executing a policy portion of the composed computer-implemented service further comprises:
imposing a constraint on the service portion of said composed computer-implemented service if a predetermined condition is met.

22. The service-execution computing system of claim 21, wherein said step of executing a policy portion of the composed computer-implemented service further comprises:
calling, by said policy portion, a service to implement said constraint.

23. The service-execution computing system of claim 20, wherein the service portion of the composed computer-implemented service and the policy portion of the composed computer-implemented service are defined in different languages.

24. The service-execution computing system of claim 23, wherein the policy portion of the composed computer-implemented service is defined in a declarative access control language.

25. The service-execution computing system of claim 24, wherein the policy portion of the composed computer-implemented service is defined in an enhanced eXtensible Access Control Markup Language.

26. The service-execution computing system of claim 25, wherein the enhanced Xtensible Access Control Markup Language comprises a binding keyword and a processing keyword.

27. The service-execution computing system of claim 20, wherein the service portion of the composed computer-implemented service is defined in a Web Ontology Language.

28. The service-execution computing system of claim 20, wherein the composed computer implemented service comprises a composed Web service.

29. A computer-readable medium having instructions to be executed on one or more processors, the instructions configured to perform a method, the method comprising:
specifying a service;
mapping the service to a process, the process including a policy operation affecting a behavior of the service;
performing the policy operation affecting the behavior of the service to result in a first process outcome; and
mapping the first process outcome to an external service.
